(19) United States
(12) Patent Application Publication
(10) Pub. No.: US 2004/0067280 A1
(43) Pub. Date: Apr. 8, 2004

(54) Method of deacidifying drinks

(75) Inventors: Jean Bonnet, Angers (FR); Herve De Vilmorin, Bordeaux (FR)

Correspondence Address: YOUNG & THOMPSON, 745 SOUTH 23RD STREET 2ND FLOOR, ARLINGTON, VA, 22202

(73) Assignees: VASLIN BUCHER, CHALONNES SURE LOIRE (FR); INDAGRO GASQUET, BORDEAUX (FR)

(21) Appl. No.: 10/673,168

(22) Filed: Sep. 30, 2003

(30) Foreign Application Priority Data
Sep. 30, 2002 (FR) 02 12089

(51) Int. Cl. A23K 1/00

(52) U.S. Cl. 426/51

(57) ABSTRACT

The invention concerns a method of deacidifying drinks.

Method of deacidifying drinks, especially fermented ones, containing acid compounds and in particular acetic acid, characterised in that it comprises carrying out the following operations:

subjecting the drink to be treated to nanofiltration or reverse osmosis to obtain a retained substance (R1) and a permeated substance (P1), the latter still containing part of the acetic acid from the initial drink;

neutralising the acidity of the permeated substance (P1) by controlled addition of at least one basic compound which reacts with the acid compounds in the permeated substance (P1) to form corresponding salts;

subjecting the permeated substance (P1) to nanofiltration or reverse osmosis to obtain a retained substance (R2) and a permeated substance (P2), the latter being substantially free from the reaction salts present in (P1);

mixing the retained substance (R1) and the permeated substance (P2) to form the final deacidified drink.

The invention concerns methods of treating liquids, particularly liquids for human consumption, with a view to changing their composition and/or taste, nutritional or similar properties.

The subject of the invention is a method of deacidifying drinks, especially fermented ones and in particular drinks based on grape juice.

The preparation of drinks, particularly fermented ones, is often accompanied by the production of volatile compounds which degrade the organoleptic quality of the drinks.

The most well-known of these undesirable compounds is acetic acid, which is present in acid drinks in free, salified and esterified forms.

The danger of excessive production of volatile acidity is greatest with liquids which undergo alcoholic fermentation (conversion of sugars to ethyl alcohol) when the percentage of alcohol obtained is over 13%. The danger is increased where the sugars are incompletely fermented and where the fermentation temperatures are above 28° C.

This is a very real danger, particularly affecting red wines with an ethanol content above 13% by volume.

Methods of reducing the volatile acidity of some drinks are already known (from the documents WO93/23151 and WO01/78881 for example).

These known methods use:

a first stage of nanofiltration or reverse osmosis of the drink (producing a retained substance R1 and a permeated substance P1).

a second stage of treating the permeated substance P1 with slightly anionic ion exchange resins, at the end of which a treated permeated substance P2 is obtained.

a third stage of combining the retained substance R1 with the treated permeated substance P2.

The above methods have limitations connected with the use of ion exchange resins, namely:

compulsory, restrictive resin-regenerating cycles; these cycles are highly technical and use hazardous substances: sulphuric acid, caustic soda, ammonia or the like.

difficulties in determining the saturation of the resins and hence a danger of salting out.

the need to control the quantity passing through.

a danger of the drink being contaminated if the resins are not well prepared (smell of ammonia) or well selected (incompatible with edible applications).

the limited life of the resins (less than 10 years).

relatively high cost of the treatment: long-term costs of the column+resin+regenerations+labour. The charges normally made for providing the service are of the order of 0.4 ε/l for lowering by 0.5 g/l. the volatile acidity, expressed as acetic acid.

the very large volume of effluents produced: 500 litres of sodium hydroxide solution+1000 litres of rinsing water for regenerating a column of 200 litres of resins for example.

compulsory preservation of the resins between two periods of use.

The invention aims greatly to reduce and, if possible, eliminate the above-mentioned disadvantages by proposing an alternative method which does not use ion exchange resins.

To this end the subject of the invention is a method of deacidifying drinks, especially fermented ones, containing acid compounds and in particular acetic acid, characterised in that it comprises carrying out the following operations:

subjecting the drink to be treated to nanofiltration or reverse osmosis to obtain a retained substance R1 and a permeated substance P2, the latter still containing part of the acetic acid from the initial drink;

neutralising the acidity of the permeated substance P1 by controlled addition of at least one basic compound which reacts with the acid compounds in the permeated substance P1 to form corresponding salts;

subjecting the permeated substance P1 to nanofiltration or reverse osmosis to obtain a retained substance R2 and a permeated substance P2, the latter being substantially free from the reaction salts present in P1;

mixing the retained substance R1 and the permeated substance P2 to form the final deacidified drink.

Two practical embodiments can be envisaged for carrying out the controlled addition of basic compound to the permeated substance P1.

Thus the controlled addition of basic compound to the permeated substance P1 may be carried out by adding a predetermined quantity of such a compound, previously calculated according to the quantity of liquid to be treated and the reduction in volatile acidity to be obtained.

Said controlled addition may alternatively be carried out by monitoring the change in the pH of said permeated substance in real time as an increasing quantity of said basic compound is blended in.

The deacidification method of the invention may easily be applied to very different quantities requiring treatment, by appropriately adapting the treatment installation.

In a first embodiment of the invention, more particularly adapted to small quantities of drinks to be treated and allowing the costs of the equipment used to be limited, the method may be carried out discontinuously, with the initial drink and the permeated substance P1 with neutralised acidity being treated by the same nanofiltration or reverse osmosis installation, in two separate operating phases.

In a second embodiment of the invention, more particularly adapted to large quantities to be treated and allowing continuous flow treatment, the process may comprise a continuous treatment method where the treatment operations are carried out in series, the initial drink and the permeated substance P1 with neutralised acidity being treated by two different nanofiltration or reverse osmosis installations, arranged in series in a treatment line or loop.

A very advantageous but non-restrictive application of the invention is in the field of treatment of drinks obtained from grapes or containing grape juice.

In that case in particular the basic compound is preferably potassium hydroxide and the membrane or membranes used for nanofiltration or reverse osmosis have a high rejection rate, preferably above about 95%, relative to the potassium and potassium salts.

According to another feature of the invention the membrane or membranes used for nanofiltration or reverse osmosis further have a high rejection rate, preferably above about 95%, relative to malic and tartaric acid.

The invention will be understood better from the description below, relating to preferred embodiments. These are given as non-restrictive examples and will be explained with reference to the accompanying diagrammatic drawings in which:

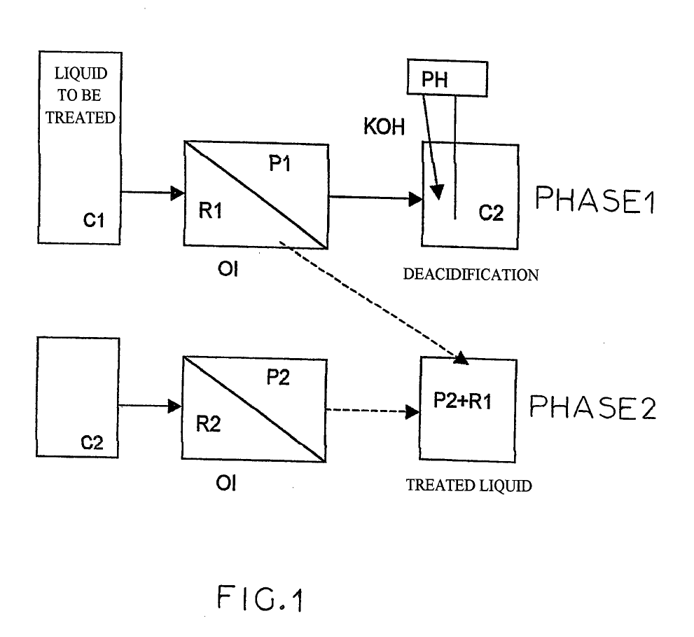

FIG. 1 is a diagram showing the use of the method of the invention in two phases, in a first, discontinuous embodiment, and

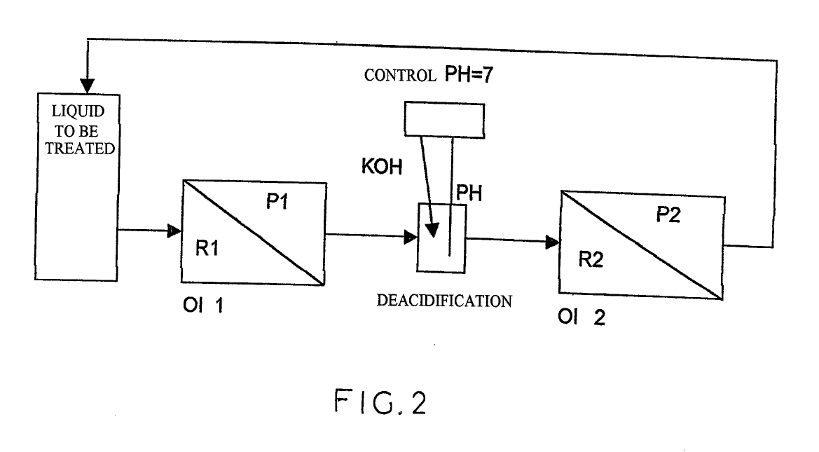

FIG. 2 is a diagram showing the use of the method of the invention relative to a second, continuous-flow embodiment.

The processing method according to the invention may be divided into four separate, consecutive operations or stages in the treatment.

A first stage of nanofiltration or reverse osmosis of the initial drink enables a retained substance (R1) and a permeated substance (P1) rich in acetic acid to be obtained. The other acids in the drink, tartaric and malic acid for example in the case of wine, are strongly retained by membranes of the OI or OII osmosis unit: the rejection rate for tartaric or malic acid by reverse osmosis membranes may be as high as 99%, whereas the rejection rate for acetic acid under the same conditions is of the order of 50%. These membranes also have a high rejection rate for potassium (>95%). The membranes may e.g. be of the type known under reference SC by DESAL/OSMONICS.

A second stage comprises neutralising the acidity of the permeated substance P1 using a strong base, e.g. potash (KOH). Neutralisation may be controlled simply by measuring the change in the pH and by stopping the addition of base when the pH>7. The acetic acid in the permeated substance P1 is thus converted to potassium acetate. This salt is highly soluble: 2530 g/l at 20° C.

A third stage comprises subjecting the permeated, deacidified substance P1 to total osmosis, thus obtaining the retained substance R2 and the permeate P2. As the permeated substance P1 has already undergone osmosis the second osmosis is relatively easy. Owing to the high potassium rejection rate of the membrane of the OI or OI2 osmosis unit virtually all the potassium acetate is retained in the substance R2, corresponding to the dead volume of the osmosis unit in question at the end of the treatment. Owing to the high solubility of potassium acetate there is no danger of crystallisation during the concentration of R2.

A fourth operation comprises combining the retained substance R1 and the permeated substance P2 obtained at the preceding stage, to obtain the final deacidified product.

One of the advantages of the invention is that the volatile acidity of the drink can be decreased using only one machine or installation, as shown in FIG. 1 of the accompanying drawings. The two phases illustrated in this figure use the same OI osmosis unit.

In order to provide continuous treatment it would however be possible to use two machines or installations (osmosis units OI 1 and OI 2) and automatic neutralisation of the permeated substance P1 as shown in FIG. 2.

In the latter case the final osmosis unit (OI2) may be smaller than the first (OI1), allowing for the ease of the second osmosis and the volumes to be treated.

It is clearly possible to use a base other than potassium hydroxide (e.g. sodium or calcium hydroxide) to neutralise the volatile acidity. Potash is however preferred for the treatment of drinks produced from grapes, as grape juice or wine has a very high potassium content, and secondly as potassium acetate is highly soluble and hence there is no danger of crystals forming during the concentration of the substance retained at the second osmosis. The quantities of basic materials used are smaller than those required for the preparation and regeneration of resins. The economic results for the method of the invention are very favourable.

The method of the invention has another practical advantage which is very important for the operator: it is possible to determine the end of the treatment, simply and in real time, without considering the actual volumes treated.

If the decrease in volatile acidity to be obtained and the total volume of liquid to be treated are known, it is possible to calculate the volume of KOH (for example) to be used. When that quantity of potash has been used up in neutralising the permeated substance P1, this means that all the excess acidity has been eliminated and the first osmosis has to be stopped.

The reaction: CH₃ COOH+K OH→CH₃ COOK+H₂O shows that in order to neutralise 60 g of acetic acid 56 g of potash has to be used

If:

A is the decrease in volatile acidity to be obtained in g/l of acetic acid,

V is the volume of liquid to be treated in litres and

T is the titre of the KOH solution in g/l, then

the volume Q of KOH solution to be used equals:

56.A.V/60.T litres

Now T is known, and therefore Q=kAV.

The invention is not of course limited to the embodiments described and shown in the accompanying drawings. Changes can still be made, particularly in respect of the make-up of the various elements or by substitution of equivalent methods, without thereby going beyond the scope of protection of the invention.

1. Method of deacidifying drinks, especially fermented ones, containing acid compounds and in particular acetic acid, characterised in that it comprises carrying out the following operations:
subjecting the drink to be treated to nanofiltration or reverse osmosis to obtain a retained substance (R1) and a permeated substance (P1), the latter still containing part of the acetic acid from the initial drink;
neutralising the acidity of the permeated substance (P1) by controlled addition of at least one basic compound which reacts with the acid compounds in the permeated substance (P1) to form corresponding salts;
subjecting the permeated substance (P1) to nanofiltration or reverse osmosis to obtain a retained substance (R2) and a permeated substance (P2), the latter being substantially free from the reaction salts present in (P1);
mixing the retained substance (R1) and the permeated substance (P2) to form the final deacidified drink.

2. Method according to claim 1, characterised in that the controlled addition of basic compound to the permeated substance (P1) is carried out by adding a predetermined quantity of such a compound, previously calculated according to the quantity of liquid to be treated and the reduction in volatile acidity to be obtained.

3. Method according to claim 1, characterised in that the controlled addition of basic compound to the permeated substance (P1) is carried out by monitoring the change in the pH of said permeated substance in real time as an increasing quantity of said basic compound is blended in.

4. Method according to any one of claims 1 to 3, characterised in that it is carried out discontinuously, with the initial drink and the permeated substance (P1) with neutralised acidity being treated by the same nanofiltration or reverse osmosis installation, in two separate operating phases.

5. Method according to any one of claims 1 to 3, characterised in that it comprises a continuous treatment method where the treatment operations are carried out in series, the initial drink and the permeated substance (P1) with neutralised acidity being treated by two different nanofiltration or reverse osmosis installations, arranged in series in a treatment line or loop.

6. Method according to any one of claims 1 to 5, characterised in that, particularly in the case of treatment of drinks obtained from grapes or containing grape juice, the basic compound is preferably potassium hydroxide and the membrane or membranes used for nanofiltration or reverse osmosis have a high rejection rate, preferably above about 95%, relative to the potassium and potassium salts.

7. Method according to claim 6, characterised in that the membrane or membranes used for nanofiltration or reverse osmosis also have a high rejection rate, preferably above about 95%, relative to malic and tartaric acid.
